(19) United States
(12) Patent Application Publication
(10) Pub. No.: US 2025/0012659 A1
(43) Pub. Date: Jan. 9, 2025

(54) Method of Determining the Status of a Cooking Appliance and Cooking Appliance

(71) Applicant: RATIONAL Aktiengesellschaft, Landsberg am Lech (DE)

(72) Inventors: Martin HEIM, Landsberg am Lech (DE); Thomas SCHREINER, Landsberg am Lech (DE)

(21) Appl. No.: 18/762,165

(22) Filed: Jul. 2, 2024

(30) Foreign Application Priority Data
Jul. 3, 2023 (DE) 10 2023 117 525.4

(51) Int. Cl. G01M 3/26; A23L 5/10; A47J 27/04

(52) U.S. Cl. CPC G01M 3/26; A23L 5/13; A47J 27/04; A47J 2027/043

(57) ABSTRACT

A method of determining the status, in particular the tightness of a cooking appliance having a steam heating system, includes the steps of: determining an actual energy demand level of the steam heating system at which the energy demand of the steam heating system is constant during operation, and determining a deviation of the actual energy demand level from a desired energy demand level and/or a deviation of the course of a plurality of actual energy demand levels from a specific course of a plurality of desired energy demand levels. A cooking appliance having a steam heating system and a control unit is furthermore provided, which is set up to execute such a method.

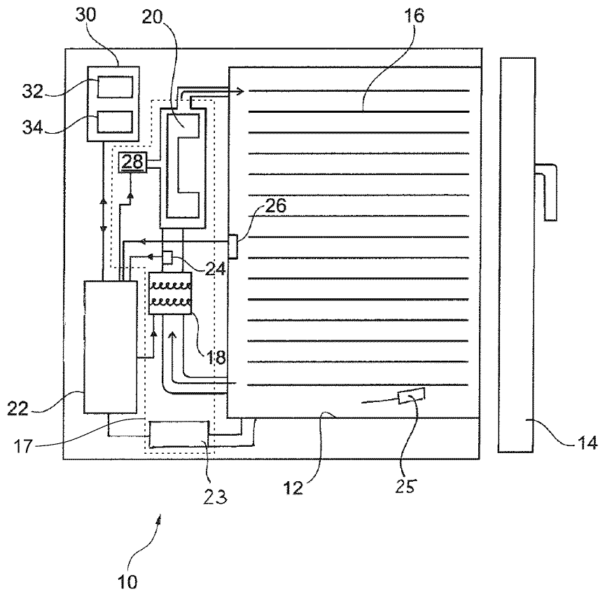

### CROSS-REFERENCE TO RELATED APPLICATIONS AND PRIORITY

This patent application claims priority from German Patent Application No. 10 2023 117 525.4 filed Jul. 3, 2023. This application is herein incorporated by reference in its entirety.

### FIELD OF THE DISCLOSURE

The invention relates to a method of determining the status, in particular the tightness of a cooking appliance having a steam heating system. Furthermore, the invention relates to a cooking appliance having a steam heating system and a control unit and which is set up to execute such a method.

### BACKGROUND

Cooking appliances having a steam heating system are known and set up to steam a cooking product present in the cooking chamber in a mode of operation in which the steam heating system is activated.

Steaming is a generally known method by means of which food can be cooked by being exposed to water vapor generated by heating a liquid, usually water. The food is cooked such that it does not come in direct contact with the liquid. In this way, a gentle cooking process is achieved, without the cooking product leaching out. A further advantage consists in that the spices are not washed off the food already seasoned.

The energy demand of a cooking appliance when new and in a mode of operation in which the steam heating system is activated is known. With increasing age of the cooking appliance, the energy demand may increase due to wear of individual components or due to the ageing of the seals. The cooking appliance is operated in a special test mode to determine the status of the cooking appliance or this change in the energy demand.

The object of the invention is to provide a method by means of which the status, in particular the tightness of a cooking appliance having a steam heating system can be determined with little effort. The object of the invention is further to provide a cooking appliance the status of which can be determined using such a method.

The object is achieved by a method of determining the status, in particular the tightness of a cooking appliance having a steam heating system, comprising the steps of:
a) determining an actual energy demand level of the steam heating system at which the energy demand of the steam heating system is constant during operation, and
b) determining a deviation of the actual energy demand level from a desired energy demand level and/or a deviation of the course of a plurality of actual energy demand levels from a specific course of a plurality of desired energy demand levels.

Within the meaning of the invention, constant means that the change in the energy demand of the steam heating system is below a defined threshold value during a period of operation.

When the cooking appliance is empty, i.e. without any cooking product in the cooking chamber, the cooking chamber is filled with steam within a few minutes in a mode of operation in which the steam heating system is activated. It then takes approximately 30 minutes until the cooking appliance is fully heated. From this point in time, the energy demand of the cooking appliance, which corresponds to the losses, is constant.

If a cooking product is in the cooking chamber, it must be additionally heated. From the time at which the cooking product has reached the temperature of the cooking chamber, the energy flow into the cooking product stops. If the cooking appliance is also already fully heated, the energy demand of the cooking appliance corresponds to its energy demand in the empty mode.

According to the invention, it has been found that for a cooking appliance in operation, it is sufficient to find an operating state in which the energy demand no longer changes, i.e. an actual energy demand level. The loaded state does not have to be taken into consideration.

Furthermore, it has been recognized according to the invention that the energy demand can be reduced to the activity of the steam heating system and thus to the energy demand thereof. The activity of the steam heating system is known from the on and off states and can thus be recorded with little effort.

Consequently, the losses of the cooking appliance and thus the status or condition thereof, in particular the tightness thereof, can be determined from the deviation of the actual energy demand level of the steam heating system from a defined comparative value in the form of a desired energy demand level. This is because if the energy demand and thus the actual energy demand level increases, this is an indication of an increased leakage of the cooking appliance.

In one embodiment, the actual energy demand level is determined exclusively on the basis of the course of the energy demand of the steam heating system during operation, the method being thus particularly efficient.

Additionally or alternatively, it may be provided, that the determination of the actual energy demand level is carried out during a cooking operation, i.e. with a cooking product. The status of the cooking appliance can thus be determined during everyday operation at the customer's premises, without an empty operation or a special test operation being necessary therefor.

In a further embodiment, the actual energy demand level is determined on the basis of a plurality of intervals during operation. It is thus possible to reliably determine a value for the actual energy demand level using simple mathematical means.

Furthermore, it may be provided that the desired energy demand level and/or the specific course of a plurality of desired energy demand levels depend(s) on the age of the cooking appliance, on the total operating time of the cooking appliance and/or on the total operating time of the steam heating system. In this way, the cooking appliance can be compared with a basic group of cooking appliances of a comparable age and/or a comparable total operating time via the desired energy demand level. Significant deviations can be an indication of damage to a seal, for example.

Alternatively, the desired energy demand level may correspond to an initial energy demand level which is assigned to the new state of the cooking appliance. Such a comparison provides information on how strongly the efficiency of the cooking appliance has decreased compared to its new state.

According to the invention, a cooking appliance having a steam heating system and a control unit is also provided to achieve the aforementioned object, which is set up to execute a method according to the invention with the aforementioned advantages.

### BRIEF DESCRIPTION OF THE DRAWINGS

Further advantages and features will become apparent from the description below and from the accompanying drawing.

The FIGURE shows a schematic view of a cooking appliance according to the invention having a control unit for executing a method according to the invention.

### DETAILED DESCRIPTION OF THE DRAWINGS

The FIGURE shows a cooking appliance 10 which is intended for professional use in large catering businesses, restaurants, canteens, etc.

The cooking appliance 10 has a cooking chamber 12 which is accessible from the outside by opening a door 14 to load the cooking chamber 12 with a cooking product.

Cooking chamber accessories 16 are arranged in the cooking chamber 12, as schematically indicated here, for example a varying number of baking trays, grill plates, baking tins or grids on which the products to be cooked are located.

To generate a desired cooking chamber atmosphere, a steam heating system 17 is provided, which has a heating device 18, a circulation device 20 in the form of a motor-driven fan wheel for circulating the atmosphere present in the cooking chamber 12, also referred to as cooking medium, and a steam generator 23.

In an alternative embodiment, the circulation device 20 is not part of the steam heating system 17 and is thus provided separately from the steam heating system 17.

The steam generator 23 has, for example, a steam module coupled to a water connection, by means of which the moisture content of the cooking medium is brought to a predetermined value. A permanent water supply is ensured via the water connection.

Further components, such as a deglazing box, a microwave heating system, etc., are furthermore optionally also provided.

Energy is supplied via gas and electrical connections.

The cooking appliance 10 also has a control unit 22, which is set up to determine the energy demand of the steam heating system 17.

The control unit 22 is also connected in a signal-transmitting manner to a temperature sensor 24, which is here arranged directly downstream of the heating device 18, wherein a temperature sensor may additionally or alternatively be present directly in the cooking chamber 12.

Furthermore, a core temperature sensor 25 can also be provided, which can be inserted into the cooking product to sense the core temperature thereof.

Furthermore, a humidity sensor 26 is provided, which is arranged inside the cooking chamber 12 in the example shown.

Further sensors, such as a sensor for detecting the pressure in the cooking chamber, a sensor for detecting the open state or the closed state of the door 14 and the door opening angle, sensors for detecting the outside temperature or the degree of browning of the cooking product, or sensors for detecting the load quantity are omitted for simplification. However, such sensors can also be present individually or in combination.

Among other things, the control unit 22 controls the heating device 18, a drive motor 28 of the circulation device 20 and the steam generator 23.

An operating unit 30 having a display 32 and an operating control 34 that enables the output of signals and the input of commands, respectively. The display and operating control 32, 34 can also be combined with each other by a touch screen. In addition, the operating unit 30 can also emit acoustic signals, for example notification or warning tones.

Numerous cooking programs are stored in the control unit 22, which are adapted to the cooking product and the individual wishes of the operator. However, different cooking chamber temperatures, cooking chamber atmospheres or operating modes can additionally be set by the operator, or the cooking programs can be changed. It is also possible to store cooking programs created by the operator.

Resource-optimized parameters are stored and saved in the control unit 22 for various cooking programs, such as the resource-optimized roasting of a chicken or a pig, possibly also taking into account the various desired degrees of browning. In addition, optimized loading times are for example stored depending on the loading quantities, which can be achieved through tests with fast loading or correspondingly fast removal. Optimum core temperatures and core temperature profiles for different cooking products are also stored. This is only a list of individual possible stored information, which can be supplemented further.

The operating state of the cooking appliance and the individual components thereof is monitored, preferably permanently, via the control unit 22. The data obtained on the corresponding parameters is stored.

One of these parameters is the energy demand of the steam heating system 17.

Furthermore, the control unit 22 is set up to carry out the method described below to determine the status, in particular the tightness, of the cooking appliance 10.

First, an actual energy demand level of the steam heating system 17 is determined, at which the energy demand of the steam heating system 17 is constant during operation.

The actual energy demand level can be determined during a cooking operation.

To determine the actual energy demand level of the steam heating system 17, the course of the energy demand of the steam heating system 17 is divided into several intervals.

In one embodiment, the course of the energy demand of the steam heating system 17 is restricted to a period between two successive fillings of the steam generator 23, so that the intervals are assigned to an operating state in which the cooking appliance 10 is operated with one filling of the steam generator 23.

In a further embodiment, the course of the energy demand of the steam heating system 17 is considered over a period with several fillings of the steam generator 23. Here, each interval can correspond to the period between two successive fillings of the steam generator 23.

The mean value of the energy demand of the steam heating system 17 is determined for each interval, for example as a percentage of a maximum energy demand of the steam heating system 17 or the power thereof over the period under consideration.

A plurality of intervals, for example five intervals, are evaluated, in that the mean values thereof are compared. If the change in the intervals in relation to each other is below a predetermined threshold value, the cooking appliance, including any cooking product present in the cooking chamber 12, is considered to be fully heated.

The actual energy demand level of the steam heating system 17 is formed by one of the evaluated mean values, for example the mean value of the last recorded interval.

Alternatively, the mean value can be formed from the evaluated mean values and can be defined as actual energy demand level of the steam heating system 17.

In an alternative embodiment, the mean values of the intervals are fitted exponentially. The asymptote of the exponential fits forms by the actual energy demand level of the steam heating system 17.

Basically, the actual energy demand level of the steam heating system 17 can be determined using any suitable mathematical method based on the course of the energy demand of the steam heating system 17.

In a next step, the determined actual energy demand level is compared with a desired energy demand level which corresponds to the typical energy demand level of a cooking appliance of the same age as the cooking appliance 10, to determine the status of the cooking appliance 10.

The deviation indicates the status of the cooking appliance 10, i.e. how good the state of the cooking appliance 10 is compared with other cooking appliances of the same age, in particular with regard to the tightness thereof.

A small deviation or no deviation means that the cooking appliance 10 is in a typical state corresponding to its age.

A significant positive or negative deviation indicates that the cooking appliance 10 is in a considerably better or worse state than would be expected due to its age.

Additionally or alternatively, the determined actual energy demand level can be compared with a desired energy demand level which corresponds to the typical energy demand level of a cooking appliance having the same total operating time or the same total operating time of the steam heating system as the cooking appliance 10.

Furthermore, it is additionally or alternatively possible to compare the course of a plurality of actual energy demand levels with a specific course of a plurality of desired energy demand levels to determine a deviation.

Furthermore, the determined actual energy demand level can be compared with a desired energy demand level which corresponds to the initial energy demand level of the cooking appliance 10, to determine a deviation from the new state of the cooking appliance 10.

The desired energy demand level or the courses thereof can be stored in the control unit 22 or in an external database which the control unit 22 can access, for example via the Internet.

In this way, a method and a cooking appliance 10 set up to execute such a method, are provided, by means of which the status of the cooking appliance 10 can be determined effectively and with little effort.

1. A method of determining the status, in particular the tightness of a cooking appliance having a steam heating system, comprising the steps of:
determining an actual energy demand level of the steam heating system at which the energy demand of the steam heating system is constant during operation; and
determining a deviation of the actual energy demand level from at least one of a desired energy demand level and a deviation of the course of a plurality of actual energy demand levels from a specific course of a plurality of desired energy demand levels.

2. The method according to claim 1, wherein the actual energy demand level is determined from the course of the energy demand of the steam heating system during operation.

3. The method according to claim 1, wherein the determination of the actual energy demand level is identified during the cooking operation.

4. The method according to claim 1, wherein the actual energy demand level is determined from a plurality of intervals during operation.

5. The method according to claim 1, wherein at least one of the desired energy demand level and the specific course of a plurality of desired energy demand levels depends on at least one of the age of the cooking appliance, the total operating time of the cooking appliance and on the total operating time of the steam heating system.

6. The method according to claim 1, wherein the desired energy demand level corresponds to an initial energy demand level assigned to the new state of the cooking appliance.

7. The method according to claim 1, further comprising:
using the deviation of the actual energy demand level to determine a tightness parameter of the cooking appliance; and
determining a quality of a seal disposed on the cooking appliance using the tightness parameter.

8. The method according to claim 7, further comprising:
executing a decision of one of keeping the cooking appliance and disposing of the cooking appliance based on the tightness parameter and the quality of the seal.

9. The method according to claim 1, further comprising:
turning on the cooking appliance to at least one of a special test mode and a cooking mode; and
waiting an amount of time for the cooking appliance to reach a constant energy demand level.

10. The method according to claim 1, further comprising;
obtaining values from a sensor disposed in the cooking appliance;
transmitting the values from the sensor to a control unit, wherein the control unit is configured to perform the step of determining the actual energy demand level and the step of determining the deviation of the actual energy demand level;
storing the actual energy demand level and the deviation of the actual energy demand level in the control unit; and
outputting a status of the cooking appliance determined from the deviation of the actual energy demand level.

11. A cooking appliance comprising a steam heating system and a control unit, wherein the cooking appliance is configured to execute the method of claim 1.
